(19) United States
(12) Patent Application Publication
(10) Pub. No.: US 2021/0304059 A1
(43) Pub. Date: Sep. 30, 2021

(54) METHOD FOR SELECTING DATASETS FOR UPDATING AN ARTIFICIAL INTELLIGENCE MODULE

(71) Applicant: International Business Machines Corporation, Armonk, NY (US)

(72) Inventors: Rafal Bigaj, Krakow (PL); Lukasz G. Cmielowski, Krakow (PL); Pawel Slowikowski, Krakow (PL); Wojciech Sobala, Krakow (PL)

(21) Appl. No.: 16/830,905

(22) Filed: Mar. 26, 2020

(51) Int. Cl. G06N 20/00; G06F 17/18

(52) U.S. Cl. CPC G06N 20/00; G06F 17/18

(57) ABSTRACT

A computer-implemented method for selecting a dataset from given datasets for updating an artificial intelligence module (AI-module). The given datasets each comprise an input dataset and a corresponding output dataset. The computer-implemented method comprises: obtaining values of parameters for defining different clusters of the given datasets, determining a metric of each given dataset, the metric of each given dataset being dependent on a level of membership of the respective given dataset to one of the clusters and a distance of the respective given dataset to a centroid of the same one of the clusters, and selecting at least one of the given datasets from the given datasets for updating the AI-module on the basis of a comparison of the metrics of the given datasets.

### BACKGROUND

The present invention relates to the field of digital computer systems, and more specifically, to a method for selecting datasets for an adaption of an artificial intelligence module.

Artificial intelligence (AI) or machine intelligence is any device that perceives its environment and takes actions that maximize its chance of successfully achieving a goal. Artificial intelligence is often understood as machines or computers that mimic “cognitive” functions that humans associate with the human mind, such as speech recognition, learning, reasoning, planning, and problem solving. Machine learning, a subset of artificial intelligence, allows a device to automatically learn from past data without using explicit instructions, relying on patterns and inferences instead. Machine learning algorithms build a mathematical model based on sample data, known as “training data,” in order to make predictions or decisions without being explicitly programmed to perform the task. The machine learning algorithms are updated or retrained as new training data becomes available.

### SUMMARY

In the course of an application of a trained artificial intelligence module (AI-module), it might occur that it is aimed to improve the AI-module. Such an improvement may be performed by updating, preferably retraining, the AI-module by using additional datasets which have not been used to train or validate the AI-module. These additional datasets may be gathered by logging input datasets applied to the AI-module into a log file and by logging corresponding output datasets calculated by the AI-module on the basis of the input datasets into a log file.

Various embodiments of the present invention provide a computer implemented method for selecting a dataset from given datasets for updating an artificial intelligence module (AI-module), a computer program product, and a computer system as described by the subject matter of the independent claims. Advantageous embodiments are described in the dependent claims. Embodiments of the present invention can be freely combined with each other if they are not mutually exclusive.

According to one embodiment, the present invention includes a computer implemented method for selecting a dataset from given datasets for updating an artificial intelligence module (AI-module), the given datasets comprising each an input dataset and a corresponding output dataset. The computer-implemented method comprises: obtaining values of parameters for defining different clusters of the given datasets, determining a metric of each given dataset, the metric of each given dataset being dependent on a level of membership of the respective given dataset to one of the clusters and a distance of the respective given dataset to a centroid of the same one of the clusters, and selecting at least one of the given datasets from the given datasets for updating the AI-module on the basis of a comparison of the metrics of the given datasets.

According to another embodiment, the present invention includes a computer program product for selecting a dataset from given datasets for updating an artificial intelligence module (AI-module), the given datasets comprising each an input dataset and a corresponding output dataset, the computer program product comprising a computer-readable storage medium having computer-readable program code embodied therewith, the computer-readable program code configured to implement a method comprising: obtaining values of parameters for defining different clusters of the given datasets, determining a metric of each given dataset, the metric of each given dataset being dependent on a level of membership of the respective given dataset to one of the clusters and a distance of the respective given dataset to a centroid of the same one of the clusters, and selecting at least one of the given datasets from the given datasets for updating the AI-module on the basis of a comparison of the metrics of the given datasets.

According to another embodiment, the present invention includes a computer system for selecting a dataset from given datasets for updating an artificial intelligence module (AI-module), the given datasets comprising each an input dataset and a corresponding output dataset, the computer system comprising one or more computer processors, one or more computer readable storage media, and program instructions stored on the one or more computer readable storage media for execution by the one or more computer processors to implement a method comprising:

obtaining values of parameters for defining different clusters of the given datasets, determining a metric of each given dataset, the metric of each given dataset being dependent on a level of membership of the respective given dataset to one of the clusters and a distance of the respective given dataset to a centroid of the same one of the clusters, and selecting at least one of the given datasets from the given datasets for updating the AI-module on the basis of a comparison of the metrics of the given datasets.

### BRIEF DESCRIPTION OF THE DRAWINGS

In the following, embodiments of the invention are explained in greater detail, by way of example only, making reference to the drawings in which:

FIG. 1 depicts a first computer system for selecting a dataset from given datasets for updating an AI-module and a second computer system for executing the AI-module;

FIG. 2 depicts a dataflow of the AI-module comprising request input datasets and corresponding answer output datasets;

FIG. 3 shows a logfile comprising given datasets generated from the request input datasets and the corresponding answer output datasets shown in FIG. 2;

FIG. 4 shows a concatenated parameter space comprising the given datasets shown in FIG. 3 represented by corresponding data points in the concatenated parameter space; and

FIG. 5 depicts a flowchart of a computer implemented method for selecting a dataset from given datasets shown in FIG. 3 for updating the AI-module.

### DETAILED DESCRIPTION

The description of the various embodiments of the present invention are being presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present method may enable to select the at least one of the given datasets, (hereinafter referred to as the selected dataset), dependent on the metrics of the given datasets for updating the AI-module. As mentioned above, the metric of each given dataset may be dependent on the level of membership of the respective given dataset to one of the clusters, (hereinafter referred to as the selected cluster), and a distance of the respective given dataset to the centroid of the same one of the clusters, e.g. to the centroid of the selected cluster.

The input datasets of the given datasets may have n dimensions and the output datasets of the given datasets may have k dimensions. The n dimensions of the input datasets may span an input parameter space and the k dimensions of the output datasets may span an output parameter space. The n dimensions of the input datasets and the k dimensions of the output datasets together may span a concatenated parameter space. The input parameter space, the output parameter space, and/or the concatenated parameter space may each have at least one boundary. The input and output datasets of the given datasets may comprise values, preferably real values.

The given datasets may be generated by using the AI-module in a trained state. The trained AI-module may calculate output datasets each on the basis of one of corresponding input datasets. The corresponding input datasets may each represent a request of a user of the trained AI-module and may be referred to as request input datasets. The output datasets may each represent an answer of the trained AI-module to the corresponding request input datasets and may be referred to as answer output datasets. The given datasets may be each created by concatenating each answer output dataset with the corresponding request input dataset. The given datasets may be provided by a logfile. The logfile may be created by recording the answer output dataset and the corresponding request input dataset when the trained AI-module is used by the user.

The given datasets may each be represented by a data point with coordinates being equal to values of the respective given dataset in either the input parameter space, the output parameter space, or the concatenated parameter space, depending on which part of the datasets a calculation of the metric is applied to. The phrase “exemplary distance of an exemplary dataset to an exemplary centroid” refers to the exemplary distance of an exemplary data point the exemplary dataset represents to the exemplary centroid. Similarly, the phrase “exemplary dataset being located to an exemplary centroid” refers to an exemplary data point being located to the exemplary centroid, wherein the exemplary dataset may represent the exemplary data point.

The level of membership of each given dataset to the selected cluster may be determined on the basis of the distance of each given dataset to the centroid of the selected cluster and further distances of the respective given dataset to centroids of the different clusters except the selected cluster. For example, the level of membership of each given dataset to the selected cluster may be determined on the basis of a ratio between the distance of the respective given dataset to the centroid of the selected cluster and a sum of the further distances and the distance of the respective given dataset to the centroid of the selected cluster.

The selected cluster may be selected from at least two of the different clusters of the given datasets. The values of parameters for defining the clusters may comprise values of parameters of each cluster defining that cluster. The values of the parameters of each cluster may be values of coordinates of the centroid of each cluster located in the input parameter space, the output parameter space, or the concatenated parameter space. The selected cluster may be selected manually by an expert in a field of application related to the given datasets, e.g. an engineer of a physician. In one example, the values of parameters for defining the clusters may be obtained by performing a clustering algorithm applied on the given datasets, training datasets, and/or test datasets. In another example, the values of parameters for defining the clusters may be loaded from a storage device. In this case, the values of parameters for defining the clusters may be determined prior to performing the method of the present invention.

For example, the expert may point to a location in the input parameter space, the output parameter space, or the concatenated parameter space and thereby define the values of the coordinates of the centroid of the selected cluster. This may also be possible in higher dimensions by visualizing two of three dimensional subspaces in the input parameter space, the output parameter space, or the concatenated parameter space.

In a first example, the metric of each given dataset may be calculated by the product of the level of membership of the respective given dataset to the selected cluster and the distance of the respective given dataset to the centroid of the selected cluster. In this first example, the selecting of the selected dataset may be performed such that the selected dataset may be the dataset of the given datasets with the highest metric.

According to the first example and assuming the level of membership of the selected dataset to the selected cluster being on an average level, for example compared to ten other given datasets, the selected dataset may be located comparatively far away from the centroid of the selected cluster. In this case, the selected dataset may be located closer to a boundary of the input parameter space, the output parameter space, and/or the concatenated parameter space than the other ten given datasets. This may imply that the selected dataset may include additional information to the information given by the ten other given datasets. For this reason, it may be interesting to choose the selected dataset for updating the AI-module.

Preferably, the selected dataset may be examined, for example by the expert or an additional AI-module. A result of an examination of the selected dataset may be a confirmation or a rejection of the selected dataset. The latter case may represent a case where the AI-module may have calculated the selected dataset incorrectly. In either case, the selected dataset may be used for updating the AI-module. In the latter case, the selected dataset may be corrected, preferably by the expert or an additional AI-module. Updating the AI-module may comprise a retraining of the AI-module, for example applying a backpropagation algorithm on the AI-module, using the selected dataset. As the selected dataset may comprise the additional information, updating the AI-module may contribute to store the additional information in the form of changed values of parameters of the AI-module.

In another embodiment, updating the AI-module may comprise changing one of the boundaries of the input parameter space or the output parameter space. For example, the following two cases may be considered. In the first case, the result of the examination may be the confirmation. In the second case, the result of the examination may be the rejection. In the first case, the boundary of the input parameter space may be moved further away from the selected dataset. This may have the advantage that the AI-module may be used for new datasets located within the adapted boundary of the input parameter space. In the second case, the boundary of the input parameter space may be moved such that the selected dataset may be located outside the boundary of the input parameter space. This may reduce the risk that the AI-module may calculate erroneous new output datasets for new input datasets located outside the changed boundary of the input parameter space.

Changing the boundary of the input parameter space according to the second case may provide that the new input datasets being located beyond the changed boundary of the input parameter space may not be accepted for an application of the AI-module. A rejection of the new input datasets being located beyond the changed boundary may be performed automatically using an enquiry module which may function as a gate of the AI-module for all incoming input datasets when the AI-module may be in use. The AI-module may comprise the enquiry module. The enquiry module may comprise functions with parameters, the functions working similar to filters. The enquiry module may be adapted by adapting values of the parameters of the enquiry module according to the changed boundary of the input parameter space.

A process comprising the confirmation or a correction of the selected dataset is referred herein as labelling. The labelling may be performed manually or automatically, preferably using an additional AI-module. The latter case may be useful if the additional AI-module is not permanently accessible, has better performance than the AI-module, or is less mobile compared to the AI-module. The correction of the selected dataset may comprise a correction of one of the values of the input and/or the output dataset of the selected dataset.

The present method may enable updating the AI-module on the basis of the selected dataset or datasets after the given datasets have been generated. As the selecting of the dataset or datasets may be performed dependent on the metrics of the given dataset or datasets, the location of the given dataset or datasets in the input, output, or concatenated parameter space with respect to at least one centroid of at least one of the clusters of the given datasets may be considered. This may allow to update the AI-module on the basis of the most important given dataset or datasets. The selected dataset may also be considered as the dataset of the given datasets containing the most different information. As a result, updating the AI-module may be faster and an overfitting of the AI-module may be prevented.

According to one embodiment, the method further comprises determining a metric of each cluster, the metric of each cluster being dependent on a distance of a centroid of the respective cluster to the other centroids of the clusters, selecting at least one of the clusters from the clusters on the basis of the metrics of the clusters, and determining the metric of each given dataset, the metric of each given dataset being dependent on the level of membership of the respective given dataset to the selected cluster and the distance of the respective given dataset to the centroid of the selected cluster. This embodiment may have the advantage of determining the selected cluster automatically by comparing the metrics of the clusters and may be referred to as the first embodiment in the following.

In one example, the metric of each cluster may be equal to a quotient of a mean distance of the centroid of the respective cluster to the other centroids of the clusters divided by a maximal distance between the centroids of the clusters. In a first example, the selected cluster may be the cluster with the highest metric. In this example, the given datasets which comprise a higher level of membership to the selected cluster than other given datasets may be located further away from a balance point of all the centroids of the clusters than the other given datasets. As the metrics of the given datasets may be calculated on the basis of the selected cluster, the chance that the selected dataset may be located further away from the balance point than the other given datasets may increase. This may enhance the chance that the selected dataset may comprise different information than the other given datasets.

This may enhance the chance that the former given datasets may comprise different information than the latter given datasets. Calculating the metric of each given dataset is dependent on the selected cluster.

According to one embodiment, determining the metric for each given dataset further comprises determining a set of metrics for each given dataset, each metric of the set of metrics of the respective given dataset corresponding to one cluster of a subset of the clusters, each metric of the set of metrics of the respective given dataset being dependent on the level of membership of the respective given dataset to the corresponding cluster and the distance of the respective given dataset to a centroid of the corresponding cluster, and selecting at least one of the given datasets from the given datasets for updating the AI-module on the basis of a comparison of the set of metrics of the given datasets. In one example, the subset of the clusters may comprise all clusters. In another example, the subset of the clusters may only comprise a portion of all the clusters, the subset of clusters being a proper subset of the clusters.

According to one example, the set of metrics of the given datasets may be compared by calculating a norm of each set of metrics. The selected dataset or selected datasets may be the one or the ones with the highest norm and with the highest norms respectively. This embodiment may be advantageous because the selected dataset may not only depend on one selected cluster. Thus, the results of a clustering algorithm, e.g. the k-means clustering algorithm or the fuzzy C-means clustering algorithm, may be used considering more than one cluster to perform the selecting from the given datasets.

According to one embodiment, the method further comprises generating the values of the parameters for defining the clusters as a function of the training datasets, the AI-module being generated using the training datasets. This embodiment may be referred to as the second embodiment in the following. The training datasets may comprise the same structure as the given datasets, i.e. the training datasets each comprise an input dataset and an output dataset. The function of the training datasets is described in the following and may not be limited to this embodiment.

The term “module” as used herein refers to any known or future developed hardware, software such as an executable program, artificial intelligence, fuzzy-logic or any possible combination thereof for performing a function associated with the “module” or being a result of having performed the function associated with the “module”.

The AI-module may comprise a neural net, a convolutional neural net, and/or a radial basis function net. The input dataset and the output dataset of the given datasets and the training datasets may comprise values, preferably real values, as data elements. A calculation of one of the output datasets of the given datasets and the training datasets may be performed dependent on the corresponding input dataset and on values of parameters of the AI-module. In a preferred example, the values of each output dataset of the given datasets and the training datasets may each represent a probability in which of several classes the input dataset of the given datasets and the training datasets respectively may be categorized.

The AI-module may be generated on the basis of the training datasets using machine learning. The term “machine learning” refers to a computer algorithm used to extract useful information from the input datasets and the output datasets of the training datasets. The information may be extracted by building probabilistic models in an automated way. The machine learning may be performed using one or more known machine learning algorithms such as linear regression, backpropagation, K-means, classification algorithms, etc.

A probabilistic model may, for example, be an equation or set of rules that makes it possible to predict a category on the basis of one of the input datasets of the training datasets or to associate an instance corresponding to one of the input datasets of the training datasets to a value or values of the corresponding output dataset.

The one or more known machine learning algorithms may adapt the values of the parameters of the AI-module such that a training error of the AI-module may be reduced. The training error may be calculated on the basis of deviations of calculated values of training output datasets of the AI-module calculated by the AI-module and the values of each output dataset of the respective training datasets. Each training output dataset of the AI-module may be calculated on the basis of the input dataset of the respective training dataset and may therefore be associated to the respective training dataset. The training output datasets of the AI-module may have the same structure as the output datasets of the training datasets, i.e. types of elements of the training output datasets of the AI-module may match types of elements of the output datasets of the training datasets.

Adapting the values of the parameters of the AI-module on the basis of the deviations may reduce the training error. If the training error reaches a given threshold, the AI-module may be regarded as being trained and in the trained state. In the trained state, the AI-module may be used to generate the above mentioned answer output datasets each in response to a request input dataset sent by the user to the AI-module.

The training datasets may be chosen such that the input datasets of the training datasets may be distributed as equal as possible in the input parameter space and/or that they may represent many important use cases that the AI-module may be applied to. A distribution of the training datasets may be designed such that the training error may be as low as possible. That may imply that in different regions of the concatenated parameter space, a density of the training datasets may be different. Recommended different densities of the training datasets in the concatenated parameter space may be calculated using algorithms of design of experiments (DOE). The different densities may be considered as training clusters.

Generally, the training datasets may be obtained in a supervised manner, e.g. by obtaining them considering the recommended densities, by obtaining them in supervised and/or designed experiments, and/or by selecting the training datasets from a set of experimental datasets. This kind of supervising may be performed by the expert. For that reason, the training datasets may represent a knowledge of the expert more efficiently than the given datasets. For example, the given datasets may be generated by using the AI-module in a very narrow subspace of the concatenated parameter space covering only very few different use cases of the AI-module.

Generating the values of the parameters for defining the clusters as a function of the training datasets may provide that the clusters may be understood easily by the expert and may represent a meaningful clustering of the concatenated parameter space. In addition, the clusters may reflect the different densities of the training datasets in the input, output or concatenated parameter space. Furthermore, the clustering algorithm may be performed faster compared to using only the given datasets for the clustering. Thus, in a preferred embodiment, the values of the parameters for defining the clusters may be generated using only the training datasets.

According to one embodiment, the method further comprises generating the values of the parameters for defining the clusters as a function of the given datasets. This embodiment may be referred to as the third embodiment in the following. The given datasets may represent new use cases of the AI-module which may not be comprised by training datasets. Consequently, the clusters resulting from a clustering using the given datasets may represent new regions of the input, output or concatenated parameter space containing the new use cases. The selected dataset may be located in one of the new regions and represent one of the new use cases. Thus, the AI-module may be updated using the selected dataset including new information represented by one of the new use cases.

According to one embodiment, the method further comprises generating the values of the parameters for defining the clusters as a function of the test datasets, the AI-module being tested using the test datasets. This embodiment may be referred to as the fourth embodiment in the following. The test datasets may have the same structure as the training datasets, i.e. each comprising an input and an output dataset. The test dataset may stem from the set of experimental datasets and may therefore represent the knowledge of the expert in a similar way like the training datasets. For that reason, this embodiment may have the same advantages as using only the training datasets for the clustering. If the values of the parameters for defining the clusters is generated as a function of test datasets and the training datasets, more information may be used and the clustering may better represent the knowledge of the expert. The test datasets may be used for a validation of the AI-module. The validation may be described in the following.

A validation error may be calculated on the basis of deviations of calculated values of validation output datasets of the AI-module calculated by the AI-module and the values of each output dataset of the respective test datasets. Each validation output dataset of the AI-module may be calculated on the basis of the input dataset of the respective test dataset and may therefore be associated to the respective test dataset. The validation output datasets of the AI-module may have the same structure as the output datasets of the test datasets, i.e. types of elements of the validation output datasets of the AI-module may match types of elements of the output datasets of the test datasets.

If the validation error reaches a given validation threshold, the AI-module may be regarded as being validated. If the validation error does not match the validation threshold, one of the machine learning algorithms may be performed repeatedly in order to adapt the values of the parameters of the AI-module again. The values of the parameters of the AI-module may be initialized differently in this case. If the AI-module is validated, it may provide sufficient generalization properties, i.e. calculate sufficient accurate new output datasets in the basis of new input datasets.

According to one embodiment, the method further comprises generating the values of the parameters for defining the clusters as a function of an approved or corrected dataset of the given datasets (referred to in the following as labelled dataset). An approval or correction, i.e. the labelling, of the one of the given datasets to be labelled may be performed manually by the expert or automatically, for example by the additional AI-module. The approval or correction may comprise an approval or correction of the input dataset and/or the output dataset of the one dataset to be labelled. Correcting the input dataset may be justified when values of the input dataset may be known to be erroneous, e.g. shifted by a known value. Correcting the output dataset may be done in order to correct a prediction of the AI-module. Generating the values of the parameters for defining the clusters dependent on the labelled dataset may be advantageous as the clustering may be performed on the basis of new information comprised by the labelled dataset.

According to one embodiment, the method further comprises generating the values of the parameters for defining the clusters as a function of a manually approved or manually corrected dataset of the given datasets. This embodiment may be referred to as the fifth embodiment in the following. In this embodiment, the labelled dataset may be created manually, for example by the expert as mentioned above, and by that may be created more reliably and transparently.

According to one embodiment, the method further comprises obtaining the values of parameters for defining the clusters performing the Fuzzy-C-Means clustering algorithm. This embodiment may be referred to as the sixth embodiment in the following. The Fuzzy-C-Means clustering algorithm may be applied on the given datasets, the training datasets, and/or the test datasets. The advantage of using the Fuzzy-C-Means clustering algorithm compared to using another clustering algorithm, e.g. the k-Means clustering algorithm, may be that a solution of the clustering may depend less on an initial choice of centroids of the clusters. This may lead to a more consistent solution of the clustering. Compared to the k-Means clustering algorithm, performing the Fuzzy-C-Means clustering algorithm may comprise assigning the level of membership of each given dataset to each cluster. A number of clusters may be given for performing the Fuzzy-C-Means clustering algorithm.

According to one embodiment, the method further comprises obtaining the values of the parameters for defining the clusters on the basis of the input datasets of the training datasets. Preferably, the clustering may be performed on the basis of only the input datasets of the given datasets, the training datasets, and/or the test datasets. This may be advantageous as the solution of the clustering may not depend on an accuracy of the AI-module. This may allow for the solution to be interpreted by the expert with less confusion.

According to one embodiment, the method further comprises obtaining the values of the parameters for defining the clusters on the basis of the output datasets of the training datasets. Preferably, the clustering may be performed on the basis of only the output datasets of the given datasets, the training datasets, and/or the test datasets. Often a number of values of each output dataset of the given dataset or training dataset is less than a number of values of the corresponding input dataset of the given dataset or training dataset. In this case, this embodiment may deduce that a number of the clusters may be reduced. The solution of the clustering may be easier to understand in this case. Furthermore, it may be useful to update the AI-module such that an error of a prediction of one of several classes which may be represented by the output datasets of the given dataset or training dataset may be reduced. In such a case, a clustering on the basis of only the output datasets of the given datasets, the training datasets, and/or the test datasets may be more efficient. The same one of the several classes may be represented by one of the clusters. This cluster may be chosen manually to be the selected cluster for selecting the at least one of the given datasets.

According to one embodiment, the method further comprises obtaining the values of the parameters for defining the clusters on the basis of the input datasets and the output datasets of the training datasets. Preferably, the clustering may be performed on the basis of the output and input datasets of the given datasets, the training datasets, and/or the test datasets. This embodiment may lead to clusters representing as much information of the given datasets, the training datasets, and/or the test datasets as possible.

Referring to the last three embodiments, the metric of the given datasets may be calculated on the basis of only the input datasets of the given datasets if only the input datasets of the given datasets, the training datasets, and/or the test datasets are used for the clustering. Similarly, the metric of the given datasets may be calculated on the basis of only the output datasets of the given datasets if only the output datasets of the given datasets, the training datasets, and/or the test datasets are used for the clustering. In the same way, the metric of the given datasets may be calculated on the basis of the output and the input datasets of the given datasets if the input and the output datasets of the given datasets, the training datasets, and/or the test datasets are used for the clustering.

According to one embodiment, the method further comprises determining the metric of each cluster on the basis of a mean distance of the given datasets to the centroid of the respective cluster. This embodiment may be referred to as the seventh embodiment in the following. In a preferred embodiment, the metric of each cluster may be calculated such that a higher value of the mean distance of the given datasets to the centroid of the respective cluster may provoke a lower value of the metric of the respective cluster. In this case, if the cluster with the lowest metric is the selected cluster, the selected cluster rather may be that one of the clusters in which the given datasets are more spread out within the respective cluster.

According to one embodiment, the method further comprises determining the metric of each cluster on the basis of a maximal distance of the given datasets to the centroid of the respective cluster. This embodiment may be referred to as the eighth embodiment in the following. In a preferred embodiment, the metric of each cluster may be calculated such that a higher value of the mean distance of the given datasets to the centroid of the respective cluster may provoke a higher value of the metric of the respective cluster. In this case, if the cluster with the lowest metric is the selected cluster, an outlier of the given datasets located far away from the centroid of the respective cluster may indicate that this cluster is not the selected cluster. Thus, this embodiment prevents that outliers of the given datasets may have a strong influence of a determination of the selected cluster. If the maximal distances of the given datasets to the centroids and the mean distances of the given datasets to the centroid are used together in the above described way to determine the selected cluster, this embodiment may indicate that the effect of the outliers of the given datasets on the value of the mean distances may be balanced by their effect on the maximal distances.

According to one embodiment, the method further comprises determining the metric of each cluster on the basis of a mean level of membership of the given datasets to the respective cluster. This embodiment may be referred to as the ninth embodiment in the following. Preferably, the metric of each cluster may be determined on the basis of a mean level of membership of the given datasets and the training datasets to the respective cluster. In a preferred embodiment, the metric of each cluster may be calculated such that a higher value of the mean level of membership of the given datasets and/or the training datasets to the respective cluster may result in a higher value of the metric of the respective cluster. In this case, if the cluster with the lowest metric is the selected cluster, the selected cluster rather may be that one of the clusters comprising rather more of the given datasets with a rather lower level of membership of the given datasets to the respective cluster. Thus, the selected cluster may include respective given datasets that are less clearly or easily able to be classified. If the selected dataset stems from the selected cluster determined in this way, the chance that the selected dataset may comprise new information may be increased.

In the seventh, eighth and ninth embodiments, the values of the parameters for defining the clusters may be preferably generated as a function of the training datasets and manually approved or manually corrected datasets of the given datasets. The steps according to the seventh, eighth and ninth embodiment may be repeated in response to an extension of the given datasets. The given datasets may be extended during a usage of the AI-module. During this usage, the logfile may be extended such that new given datasets may be comprised by the logfile. If there are no manually labelled datasets of the given datasets in a first iteration of performing the steps according to the seventh, eighth and ninth embodiments, the values of the parameters for defining the clusters may be preferably generated as a function of only the training datasets.

According to one embodiment, the method further comprises determining the metric of each cluster on the basis of a mean distance of the training datasets and the manually approved or manually corrected datasets of the given datasets to the centroid of the respective cluster. This embodiment may be referred to as the tenth embodiment in the following.

According to one embodiment, the method further comprises determining the metric of each cluster on the basis of a maximal distance of the training datasets and manually approved or manually corrected datasets of the given datasets to the centroid of the respective cluster. This embodiment may be referred to as the eleventh embodiment in the following.

According to one embodiment, the method further comprises determining the metric of each cluster on the basis of a mean level of membership of the training datasets and manually approved or manually corrected datasets of the given datasets to the respective cluster. This embodiment may be referred to as the twelfth embodiment in the following.

The tenth, eleventh and twelfth embodiments may have similar advantages as the seventh, eighth and ninth embodiments. Determining the metric of each cluster on the basis of the training datasets and manually approved or manually corrected datasets of the given datasets may have the advantage that the selected cluster may only be determined on the basis of approved and manually corrected datasets. As a result, the selecting of the cluster may easily be determined by the expert. However, determining the metric of each cluster on the basis of the given datasets may increase the chance that the selected cluster may comprise new information provided by the selected dataset.

According to one embodiment, the method further comprises determining the metric of each cluster on the basis of a ratio of a first sum of the number of the training datasets being comprised by the respective cluster and a number of manually approved or manually corrected datasets of the given datasets being comprised by the respective cluster, and a second sum of a total number of the training datasets and a total number of manually approved or manually corrected datasets of the given datasets. This embodiment may be referred to as the thirteenth embodiment in the following. In a preferred embodiment, the metric of each cluster may be calculated such that a higher value of the ratio may provoke a higher value of the metric of the respective cluster. In this case, if the cluster with the lowest metric is the selected cluster, the selected cluster rather may be that one of the clusters comprising rather less manually labelled datasets and training datasets. Thus, the selected cluster may rather comprise a low density of datasets.

In the tenth, eleventh, twelfth and thirteenth embodiments, the values of the parameters for defining the clusters may be preferably generated as a function of the training datasets, the test datasets, and the manually approved or manually corrected datasets of the given datasets.

Similar to the steps according to the seventh, eighth and ninth embodiments, the steps of the tenth, eleventh, twelfth and thirteenth embodiments may be repeated in response to an extension of the given datasets. If there are no manually labelled datasets of the given datasets in a first iteration of performing the steps according to the tenth, eleventh, twelfth and thirteenth embodiments, the values of the parameters for defining the clusters may be preferably generated as a function of only the training datasets and the test datasets.

According to one embodiment, the input datasets of the given datasets each comprise a value of an identification parameter and the output datasets of the given datasets each comprise a value of a performance indicator. In this embodiment, the output parameter space may comprise the performance indicator and the input parameter space may comprise the identification parameter. This may enable to determine the selected dataset according to each value of the performance indicator and/or the identification parameter of the given datasets. In addition, this embodiment may enable to update the AI-module according to values of the performance indicator.

The identification parameter may allow to associate each given dataset to a respective action of data processing. The respective action of data processing may comprise a generation of the respective given dataset. For example, considering the logfile, the identification parameter of the respective given dataset may be an identification number relating to an instance of concatenating the input dataset of the respective given dataset with the output dataset of the respective given dataset and writing them into the logfile in the form of the respective given dataset. In this example, the identification number may be increased each time the logfile is extended by another given dataset.

The input dataset of the respective given dataset may comprise first further values which may be related to the instance of generation of the respective given dataset, preferably related to the instance of generation of the output datasets of the respective given dataset. The first further values of this input dataset may comprise information about a state of an environment influencing values of the output dataset, preferably the value of the performance indicator, of the respective given dataset. In another embodiment, the value of the identification parameter may be calculated using the first further values which may be related to the instance of generation of the respective given dataset, preferably related to the instance of generation of the output datasets of the respective given dataset. The value of the identification parameter may be calculated by a first function which may map a combination of the first further values bijectively to the value of the identification parameter.

The value of the performance indicator may be related to a performance of communication. For example, if the communication is successful, the value of the performance indicator may be equal to one and zero in the alternative. The communication may be related to second further values of the respective given dataset. The second further values may specify an action, for example the communication. The communication may be specified, for example, by indicating to which destination the input dataset of the respective given dataset has been sent, which kind of information the input dataset of the respective given dataset comprises, and/or which kind of actions a sending of the input dataset of the respective given dataset may have provoked. The second further values may be contained in the input and/or output dataset of the respective given dataset.

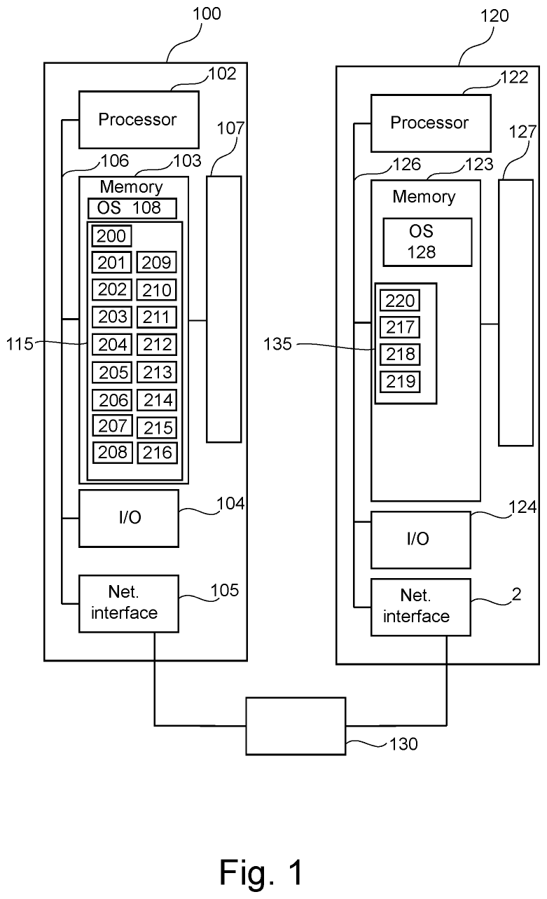

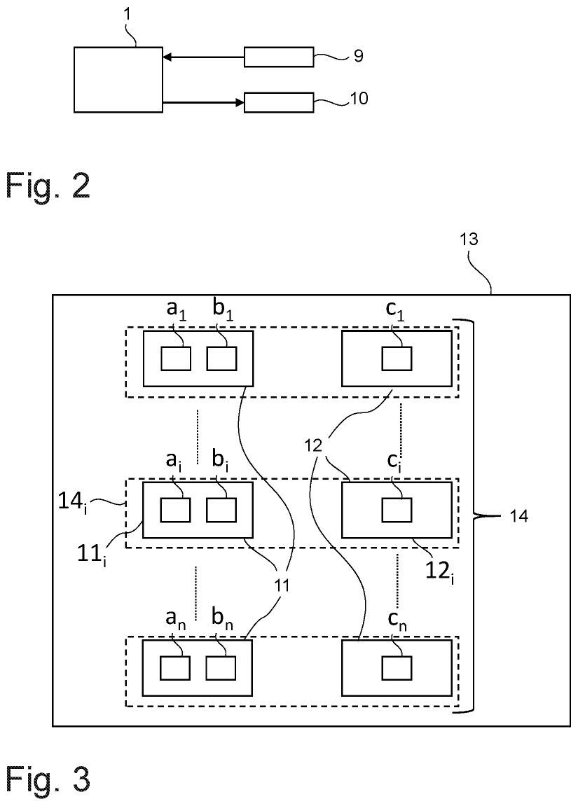

FIG. 1 shows a first computer system 100 for selecting a dataset from given datasets 14 (depicted in FIG. 3) for updating an artificial-intelligence module (AI-module) 1 (depicted in FIG. 2). The first computer system 100 may be suited for performing method steps in accordance with various embodiments of the present invention. The first computer system 100 may include a first processor 102, a first memory 103, a first I/O circuitry 104, and a first network interface 105 coupled together by a first bus 106.

The first processor 102 may represent one or more processors (e.g. microprocessors). The first memory 103 may include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), and programmable read only memory (PROM). Note that the first memory 103 may have a distributed architecture, where various components are situated remote from one another, but may be accessed by the first processor 102.

The first memory 103 in combination with a first persistent storage device 107 may be used for local data and instruction storage. The first storage device 107 includes one or more persistent storage devices and media controlled by the first I/O circuitry 104. The first storage device 107 may include magnetic, optical, magneto optical, or solid-state apparatus for digital data storage, for example, having fixed or removable media. Sample devices include hard disk drives, optical disk drives and floppy disks drives. Sample media include hard disk platters, CD-ROMs, DVD-ROMs, BD-ROMs, floppy disks, and the like.

The first memory 103 may include one or more separate programs, each of which comprises executable instructions for implementing logical functions, notably functions involved in examples. The software in the first memory 103 may also typically include a first suitable operating system (OS) 108. The first OS 108 essentially controls the execution of other computer programs for implementing at least part of methods as described herein.

The first computer system 100 may be configured to obtain values of parameters for defining different clusters of the given datasets 14, in the following referred to as first functions. The first functions may comprise loading first values which may indicate coordinates of centroids of the different clusters and second values which may indicate a level of membership of each given dataset to each of the clusters. The first functions may comprise performing a clustering algorithm, such as the Fuzzy-C-Means clustering algorithm, using the given datasets 14, the training datasets and/or the test datasets.

Furthermore, the first computer system 100 may be configured to determine a metric of each given dataset, the metric of each given dataset being dependent on each level of membership of the respective given dataset to one of the clusters and a distance of the respective given dataset to a centroid of the same one of the clusters, in the following referred to as second functions.

Furthermore, the first computer system 100 may be configured for functions such as selecting at least one of the given datasets 14 from the given datasets 14 for updating the AI-module 1 (depicted in FIG. 2) on the basis of a comparison of the metrics of the given datasets 14, in the following referred to as third functions.

Furthermore, the first computer system 100 may be configured to determine a metric of each cluster, the metric of each cluster being dependent on a distance of a centroid of the respective cluster to other centroids of the clusters, and select at least one of the clusters from the clusters on the basis of the metrics of the clusters, in the following referred to as fourth functions. The metric of each given dataset may be calculated according to one of the above described methods.

Furthermore, the first computer system 100 may be configured to generate the values of the parameters for defining the clusters according to the second, third, fourth, fifth and sixth embodiments, in the following referred to as fifth, sixth, seventh, eighth and ninth functions respectively.

Furthermore, the first computer system 100 may be configured to determine the metric of each cluster according to the seventh, eighth, ninth, tenth, eleventh, twelfth and thirteenth embodiments, in the following referred to as tenth, eleventh, twelfth, thirteenth, fourteenth, fifteenth and sixteenth functions respectively.

The first computer system 100 may perform the first, second, third, fourth, fifth, sixth, seventh, eighth, ninth, tenth, eleventh, twelfth, thirteenth, fourteenth, fifteenth and sixteenth functions by executing a first program 201, a second program 202, a third program 203, a fourth program 204, a fifth program 205, sixth program 206, a seventh program 207, an eighth program 208, a ninth program 209, a tenth program 210, an eleventh program 211, a twelfth program 212, a thirteenth program 213, a fourteenth program 214, a fifteenth program 215 and a sixteenth program 216 respectively. The first processor 102 may execute a main program 200. The main program 200 may initiate an execution of the programs 201, 202, 203, 204, 205, 206, 207, 208, 209, 210, 211, 212, 213, 214, 215 and 216 on the first processor 102 according to the particular embodiment in which the values of the parameters for defining the clusters and the metric of each cluster is determined.

The term “program” as used herein refers to a set of instructions which includes commands to provoke actions performed by the processor 102 when the processor 102 may read the commands. The set of instructions may be in the form of a computer-readable program, routine, subroutine or part of a library, which may be executed by the processor 102 and/or may be called by a further program being executed by the processor 102. Preferably the programs 200, 201, 202, 203, 204, 205, 206, 207, 208, 209, 210, 211, 212, 213, 214, 215, 216 may be executable programs which are compiled according to a type of hardware platform of the computer system 100. The first memory 103 may comprise a space for storing the programs 200, 201, 202, 203, 204, 205, 206, 207, 208, 209, 210, 211, 212, 213, 214, 215, 216, the space hereinafter referred to as first function memory 115.

FIG. 1 shows a second computer system 120. The second computer system 120 may be suitable for executing the AI-module 1 (depicted in FIG. 2).

Second computer system 120 may include a second processor 122, a second memory 123, a second I/O circuitry 124 and a network interface 2, which may be designed as a second network interface, coupled together by a second bus 126.

The second processor 122 may represent one or more processors (e.g. microprocessors). The second memory 123 may include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM). Note that the second memory 123 may have a distributed architecture, where various components are situated remote from one another, but may be accessed by the second processor 122.

The second memory 123 in combination with a second persistent storage device 127 may be used for local data and instruction storage. The second storage device 127 includes one or more persistent storage devices and media controlled by the second I/O circuitry 124. The second storage device 127 may include magnetic, optical, magneto optical, or solid-state apparatus for digital data storage, for example, having fixed or removable media. Sample devices include hard disk drives, optical disk drives and floppy disks drives. Sample media include hard disk platters, CD-ROMs, DVD-ROMs, BD-ROMs, floppy disks, and the like.

The second memory 123 may include one or more separate programs, each of which comprises executable instructions for implementing logical functions, notably functions involved in examples. The software in the second memory 123 may also typically include a second suitable operating system (OS) 128. The second OS 128 essentially controls the execution of other computer programs for implementing at least part of methods as described herein.

The second computer system 120 may be configured to execute the AI-module 1 (depicted in FIG. 2) on the second computer system 120, in the following referred to as seventeenth functions. The seventeenth functions may comprise loading a structure and values of parameters of model functions of a neural net, a convolutional neural net, and/or a radial basis function net from the second storage device 127 into the second memory 123 and calculating an answer output dataset on the basis of a corresponding request input dataset. The request input dataset on the basis which the answer output dataset may be calculated may correspond to this answer output dataset and vice versa.

As shown in FIG. 2, the AI-module 1 may calculate a set of answer output datasets 10 similarly to the answer output dataset, wherein each of the answer output datasets may be calculated on the basis of a single corresponding request input dataset of a set of request input datasets 9.

Furthermore, the second computer system 120 may be configured to receive the request input datasets 9 via the interface 2, in the following referred to as eighteenth function, and send the answer output datasets 10 via the interface 2, in the following referred to as nineteenth function.

The second computer system 120 may perform the seventeenth, eighteenth and nineteenth functions by executing a seventeenth program 217, an eighteenth program 218 and a nineteenth program 219, respectively. An execution of the programs 217, 218, 219 may be initiated by executing a second main program 220 on the second processor 122. The second memory 123 may comprise a space for storing the programs 220, 217, 218, 219, the space hereinafter referred to as second function memory 135.

The AI-module 1 (depicted in FIG. 2) may be considered as an entity comprising the structure and the values of the parameters of the model functions and program 217 for running the neural net, the convolutional neural net and/or the radial basis function net on the second processor 122 being loaded in a cache of the second processor 122.

Each one of the given datasets 14 (depicted in FIG. 3) may be created by concatenating one of the answer output datasets 10 (depicted in FIG. 2) with the corresponding one of the request input datasets 9 (depicted in FIG. 2). Preferably, each of the given datasets 14 may be divided into an input and an output dataset. Each one of the request input datasets 9 may comprise the same values as one of the input datasets 11 (depicted in FIG. 3) of the given datasets 14 and each one of the answer output datasets 10 may be the same as one of the output datasets 12 (depicted in FIG. 3) of the given datasets 14. Hence, in this example, the request input datasets 9 may become the input datasets 11 of the given datasets 14 and the answer output datasets may become the output datasets 12 of the given datasets 14 when creating the given datasets 14 from the request input datasets 9 and the answer output datasets 10.

The given datasets 14 may be provided by a logfile 13 as shown in FIG. 3. The logfile 13 may be created by storing the answer output dataset 12 and the corresponding request input datasets 11 when the trained AI-module 1 is used by a user. Preferably, each time the AI-module 1 calculates a new answer output dataset, the logfile 13 may be extended by another given dataset. In one example, the logfile 13 may be created by the second computer system 120 and stored in the second memory 123. In another example, the logfile 13 may be created by the first computer system 100, preferably by reading in the request input datasets 11 and the answer output datasets 12 separately.

In one example, the AI-module 1 may be executed on the first processor 102. However, embodiments of the present invention may be performed without having access to the AI-module 1. As this may occur more often, this example is described in FIGS. 1 and 2. Only the given datasets 14 may be required to perform embodiments of the present invention. Preferably, the given datasets may be loaded in the first memory 103 by loading the logfile 13. To realize this, the first network interface 105 may be communicatively coupled with the interface 2 via the world wide web 130 or another network.

In one example, the input datasets 11 may each comprise a first value, as shown in FIG. 3 by a₁, aᵢ, aₙ, and a second value, as shown in FIG. 3 by b₁, bᵢ, bₙ, and the output datasets 12 may each comprise a first value, as shown in FIG. 3 by c₁, cᵢ, cₙ.

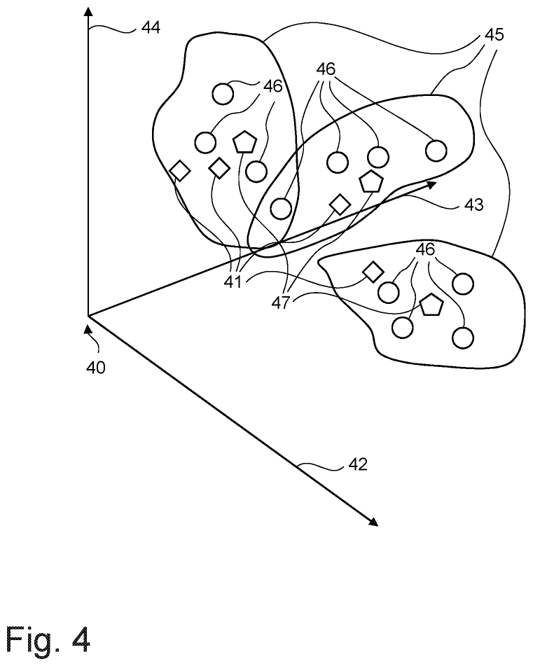

The given datasets 14 may each be represented by a data point in a coordinate system 40 (depicted in FIG. 4) with coordinates of each data point being equal to values of the respective given dataset. FIG. 4 shows some exemplary data points 41 by which the given datasets 14 may be represented. In this case, the coordinate system 40 may represent a concatenated parameter space comprising an input parameter space and an output parameter space of the given datasets 14. The input parameter space of the given datasets 14 may span an x-axis 42 and a y-axis 43 and may comprise the first values a₁, aᵢ, aₙ and the second values b₁, bᵢ, bₙ of the input datasets 11. The output parameter space of the given datasets 14 may span a z-axis 44 and may comprise the first values c₁, cᵢ, cₙ of the output datasets 12.

The AI-module 1 may be in a trained state for performing the present method. In an untrained state of the AI-module 1, the values of the parameters of the model functions may be equal to random values. This may be achieved by initialization of the AI-module 1, wherein the values of the parameters of the model functions may be set to random values. A training of the AI-module 1 may be performed on the basis of training datasets 46 (depicted in FIG. 4), each training dataset 46 comprising an input dataset and an output dataset.

The input and the output dataset of the training datasets 46 may have elements. These elements may be values, preferably real values. The input datasets of the training datasets 46 may have the same structure as the input datasets 11 of the given datasets 14. Similarly, the output datasets of the training datasets 46 may have the same structure as the output datasets 12 of the given datasets 14. The training datasets 46 may represent information about a classification problem, for which the AI-module 1 may be used, once it is trained with the training datasets 46. Regarding a first use case, the first values a₁, aᵢ, aₙ and second values b₁, bᵢ, bₙ of the respective input datasets 11 may each be a value of a feature for grouping the respective input dataset 11 into one of several different classes. A type of each different class may be given by the first values c₁, cᵢ, cₙ of the respective output datasets 12. The values of each input and output dataset of the training datasets 46 may have the same structure as the given datasets 14 and may be obtained by experiments, preferably supervised experiments.

The training of the AI-module 1 may be performed such that the values of the parameters of the model functions may be adapted to reduce a training error of the AI-module 1. The training error may be reduced as described above using one or more learning algorithms such as linear regression, backpropagation, K-means, etc.

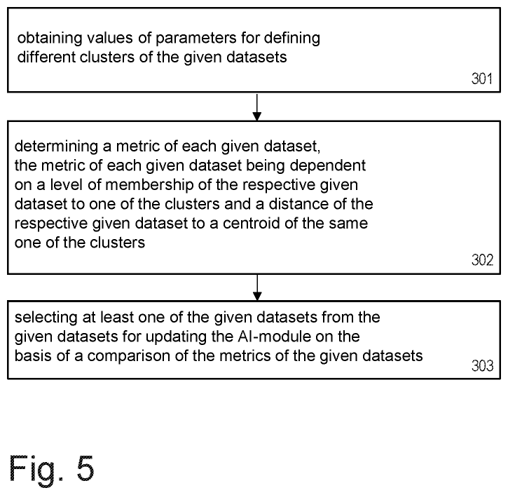

FIG. 5 shows a flowchart of a computer implemented method for selecting the dataset from the given datasets 14 for updating the AI-module 1, each given dataset 14ᵢ (depicted in FIG. 3) comprising an input dataset 11ᵢ (depicted in FIG. 3) and a corresponding output dataset 12, (depicted in FIG. 3).

In step 301, the values of the parameters for defining different clusters 45 of the given datasets 14 may be obtained. This may be realized by executing the first program 201 on the first processor 102. Running the first program 201, the Fuzzy-C-Means clustering algorithm may be performed based on the training datasets 46. This may comprise determining centroids 47 (depicted in FIG. 4) of the clusters 45 and the level of membership of each one of the given datasets 14ᵢ to each one of the clusters 45.

In step 302, the metric of each given dataset 14ᵢ may be determined. The metric of each given dataset may be dependent on the level of membership of the respective given dataset 14ᵢ to one of the clusters and the distance of the respective given dataset 14ᵢ to the centroid of the same one of the clusters.

In step 303, at least one of the given datasets 14 from the given datasets 14 for updating the AI-module 1 on the basis of the comparison of the metrics of the given datasets 14 may be selected.

In a first example, a metric of each one of the clusters 45 may be determined. The metric of each cluster of the clusters 45 may be dependent on a distance of the centroid of the respective cluster of the clusters 45 to other centroids of the clusters 45. Furthermore, one of the clusters 45 may be selected from the clusters 45 on the basis of the metrics of the clusters 45. According to this first example, the metric of each given dataset 14ᵢ may be determined such that the metric of each given dataset 14ᵢ may be dependent on the level of membership of the respective given dataset 14ᵢ to the selected cluster and the distance of the respective given dataset 14ᵢ to the centroid of the selected cluster. The distance of the respective given dataset 14ᵢ to the centroid of the selected cluster may be equal to a distance of the respective data point that may represent the respective given dataset 14ᵢ to the centroid of the selected cluster.

For example, the metric Mdatᵢ of each given dataset 14ᵢ may be calculated according to:

$$M d a {t}_{i} = \frac{1}{2} ( M + \frac{D}{M D} )$$

wherein D may be the distance of the respective given dataset 14ᵢ to the centroid of the selected cluster, MD may be the maximal distance of the given datasets 14 to the centroid of the selected cluster, and M the value of the membership of the respective given dataset 14ᵢ to the selected cluster.

According to a first variation of the first example, the metric Mclust1₁ of each one of the clusters 45, in the following referred to as cluster 451, may be determined according to:

$$M c l u s t {1}_{i} = \frac{1}{4} ( R + ( 1 - \frac{Mean D 1}{Max D 1} ) + M M 1 + M C D 1 )$$

wherein MeanD1 may be a mean distance of the training datasets 46 to the centroid of the respective cluster 45ᵢ or the mean distance of the training datasets 46 and labelled datasets to the centroid of the respective cluster 45ᵢ. The labelled datasets may each be an approved or corrected dataset of the given datasets 14. An approval or correction, i.e. a labelling, of one of the given datasets 14ᵢ to be labelled may be performed manually by an expert or automatically as mentioned above.

Furthermore, MM1 may be the mean value of the membership of the training datasets 46 to the respective cluster 45ᵢ or the mean value of the membership of the training datasets 46 and the labelled datasets to the respective cluster 45ᵢ. Furthermore, MaxD1 may be the maximal distance of the training datasets 46 to the centroids of the clusters 45 or the maximal distance of the training datasets 46 and the labelled datasets to the centroids of the clusters 45. Furthermore, MCD1 may be the mean distance from the centroid of the respective cluster 45ᵢ to the other clusters 45 divided by the maximal distance the centroids of the clusters 45. Furthermore, R may be the ratio of a first sum of the training datasets 46 and the labelled datasets comprised by the respective cluster 45ᵢ and a second sum of all training datasets 46 and all the labelled datasets.

Determining the metric Mclust1ᵢ of each one of the clusters 45 according to the second variation of the first example combines the above mentioned tenth, eleventh, twelfth and thirteenth embodiments and may produce the advantages described with these embodiments. The programs 213, 214, 215 and 216 may be executed on the first processor 102 to determine the metric Mclust1ᵢ of each one of the clusters 45 and may be called by the main program 200.

According to the first variation of the first example, the selected cluster may be the one comprising the lowest value of the metric Mclust1ᵢ. The clustering for obtaining the centroids of the clusters 45 and the values of the membership of each given dataset 14ᵢ to each one of the clusters 45 may be performed based on the training datasets 46, the above mentioned test datasets, the given datasets 14 and/or on the labelled datasets. In this case, the training datasets 46, the above mentioned test datasets, the given datasets 14, and/or on the labelled datasets may build one set of datasets for which the clustering may be performed.

According to a second variation of the first example, the metric Mclust2₁ of each one of the clusters 45 may be determined according to:

$$M c l u s t {2}_{i} = \frac{1}{3} ( ( 1 - \frac{M e a n D 2}{Max D 2} ) + M M 2 + M C D 2 )$$

wherein MeanD2 may be a mean distance of the given datasets 14 to the centroid of the respective cluster 45ᵢ. Furthermore, MM2 may be the mean value of the membership of the given datasets 14 to the respective cluster 45ᵢ. Furthermore, MaxD2 may be the maximal distance of the given datasets 14 to the centroids of the clusters 45. Furthermore, MCD2 may be the mean distance from the centroid of the respective cluster 45ᵢ to the other clusters 45 divided by the maximal distance the centroids of the clusters 45.

Determining the metric Mclust2ᵢ of each one of the clusters 45 according to the first variation of the first example combines the above mentioned seventh, eigtht, and ninth embodiments and may produce the advantages described with these embodiments. The programs 210, 211 and 212 may be executed on the first processor 102 to determine the metric Mclust2ᵢ of each one of the clusters 45 and may be called by the main program 200.

According to the second variation of the first example, the selected cluster may be the one comprising the lowest value of the metric Mclust2ᵢ. The clustering for obtaining the centroids of the clusters 45 and the values of the membership of each given dataset 14ᵢ to each one of the clusters 45 may be performed based on the training datasets 46 and/or on the labelled datasets. In this case, the training datasets 46 and/or on the labelled datasets may build one set of datasets for which the clustering may be performed.

In the following it is described how more than one dataset may be selected from the given datasets 14 on the basis of the comparison of the metrics Mdatᵢ of each given dataset 14ᵢ. In this case, the selected cluster may be determined according to the first or second variation of the first example. The minimal value Min_Mdatᵢ of the metrics Mdatᵢ and the maximal value Max_Mdatᵢ of the metrics Mdatᵢ may be determined by the comparison of the metrics Mdatᵢ of the given datasets 14ᵢ. A range comprising the minimal value Min_Mdatᵢ and the maximal value Max_Mdatᵢ as its boundaries may be divided into N equal subranges, each subrange comprising a minimal and a maximal boundary. The given datasets 14ᵢ may be grouped into N different groups according to their metric Mdatᵢ and the minimal and maximal boundary values of the N subranges. From each of the N different groups, a given number M of the given datasets may be selected. Selecting the given number M of datasets from each of the different groups may have the advantage to create a homogenous group of selected datasets from the given datasets 14 with respect to the selected cluster.

According to another example, the dataset comprising the lowest metric Mdatᵢ of all the given datasets 14ᵢ may be selected or a given number L of datasets comprising the lowest metric Mdatᵢ of all the given datasets 14ᵢ may be selected. In a further example, the dataset comprising the highest metric Mdatᵢ of all the given datasets 14ᵢ may be selected or a given number L of datasets comprising the highest metric Mdatᵢ of all the given datasets 14ᵢ may be selected.

Independent of the method in which the dataset or the datasets are selected, the selected dataset or datasets may be labelled manually or automatically in order to generate the labelled dataset or the labelled datasets mentioned above. On the basis of the labelled dataset or datasets, the clustering may be performed as described above in response to an extension of the logfile 13 with new given datasets. How the new given datasets may be created is described above.

The described process of selecting the dataset or datasets and labelling the dataset and datasets respectively may be performed repeatedly when the AI-module 1 is in use, repeatedly creating new given datasets and by that extending the logfile 13 and by that increasing the number of given datasets 14. The labelled datasets may be used to update the AI-module 1. The update may be performed in the form of a retraining similar to the above described training of the AI-module 1, but on the basis of at least the labelled datasets. The retraining may also be performed on the basis of the training datasets and the labelled datasets.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for selecting a dataset from given datasets for updating an artificial intelligence module (AI-module), the given datasets comprising each an input dataset and a corresponding output dataset, the method comprising:
obtaining values of parameters for defining different clusters of the given datasets;
determining a metric of each given dataset, the metric of each given dataset being dependent on a level of membership of the respective given dataset to one of the clusters and a distance of the respective given dataset to a centroid of the same one of the clusters; and
selecting at least one of the given datasets from the given datasets for updating the AI-module on the basis of a comparison of the metrics of the given datasets.

2. The computer-implemented method of claim 1, further comprising:
determining a metric of each cluster, the metric of each cluster being dependent on a distance of a centroid of the respective cluster to other centroids of the clusters;
selecting at least one of the clusters from the clusters on the basis of the metrics of the clusters; and
determining the metric of each given dataset, the metric of each given dataset being dependent on the level of membership of the respective given dataset to the selected cluster and the distance of the respective given dataset to the centroid of the selected cluster.

3. The computer-implemented method of claim 1, further comprising determining of the metric for each given dataset based, at least in part, on:
determining a set of metrics for each given dataset, each metric of the set of metrics of the respective given dataset corresponding to one cluster of a subset of the clusters, each metric of the set of metrics of the respective given dataset being dependent on the level of membership of the respective given dataset to the corresponding cluster and the distance of the respective given dataset to a centroid of the corresponding cluster; and
selecting at least one of the given datasets from the given datasets for updating the AI-module on the basis of a comparison of the set of metrics of the given datasets.

4. The computer-implemented method of claim 1, further comprising:
generating the values of the parameters for defining the clusters as a function of training datasets, the AI-module being generated using the training datasets.

5. The computer-implemented method of claim 1, further comprising:
generating the values of the parameters for defining the clusters as a function of the given datasets.

6. The computer-implemented method of claim 1, further comprising:
generating the values of the parameters for defining the clusters as a function of test datasets, the AI-module being tested using the test datasets.

7. The computer-implemented method of claim 1, further comprising:
generating the values of the parameters for defining the clusters as a function of an approved or corrected dataset of the given datasets.

8. The computer-implemented method of claim 1, further comprising:
generating the values of the parameters for defining the clusters as a function of a manually approved or manually corrected dataset of the given datasets.

9. The computer-implemented method of claim 1, further comprising:
obtaining the values of parameters for defining the clusters performing the Fuzzy-C-Means clustering algorithm.

10. The computer-implemented method of claim 2, further comprising:
determining the metric of each cluster on the basis of a mean distance of the given datasets to the centroid of the respective cluster.

11. The computer-implemented method of claim 2, further comprising:
determining the metric of each cluster on the basis of a maximal distance of the given datasets to the centroid of the respective cluster.

12. The computer-implemented method of claim 2, further comprising:
determining the metric of each cluster on the basis of a mean level of membership of the given datasets to the respective cluster.

13. The computer-implemented method of claim 4, further comprising:
determining the metric of each cluster on the basis of a mean distance of the training datasets and manually approved or manually corrected datasets of the given datasets to the centroid of the respective cluster.

14. The computer-implemented method of claim 4, further comprising:
determining the metric of each cluster on the basis of a maximal distance of the training datasets and manually approved or manually corrected datasets of the given datasets to the centroid of the respective cluster.

15. The computer-implemented method of claim 4, further comprising:
determining the metric of each cluster on the basis of a mean level of membership of the training datasets and manually approved or manually corrected datasets of the given datasets to the respective cluster.

16. The computer-implemented method of claim 4, further comprising:
determining the metric of each cluster on the basis of a ratio of a first sum of the number of the training datasets being comprised by the respective cluster and a number of manually approved or manually corrected datasets of the given datasets being comprised by the respective cluster and a second sum of a total number of the training datasets and a total number of manually approved or manually corrected datasets of the given datasets.

17. The computer-implemented method of claim 4, further comprising:
obtaining the values of the parameters for defining the clusters on the basis of the output datasets of the training datasets.

18. The computer-implemented method of claim 1, wherein the input datasets of the given datasets each comprise a value of an identification parameter and the output datasets of the given datasets each comprise a value of a performance indicator.

19. A computer program product for selecting a dataset from given datasets for updating an artificial intelligence module (AI-module), the given datasets each comprising an input dataset and a corresponding output dataset, the computer program product comprising a computer-readable storage medium having computer-readable program code embodied therewith, the computer-readable program code configured to implement a method comprising:
obtaining values of parameters for defining different clusters of the given datasets;
determining a metric of each given dataset, the metric of each given dataset being dependent on a level of membership of the respective given dataset to one of the clusters and a distance of the respective given dataset to a centroid of the same one of the clusters; and
selecting at least one of the given datasets from the given datasets for updating the AI-module on the basis of a comparison of the metrics of the given datasets.

20. A computer system for selecting a dataset from given datasets for updating an artificial intelligence module (AI-module), the given datasets each comprising an input dataset and a corresponding output dataset, the computer system comprising one or more computer processors, one or more computer readable storage media, and program instructions stored on the one or more computer readable storage media for execution by the one or more computer processors to implement a method comprising:
obtaining values of parameters for defining different clusters of the given datasets;
determining a metric of each given dataset, the metric of each given dataset being dependent on a level of membership of the respective given dataset to one of the clusters and a distance of the respective given dataset to a centroid of the same one of the clusters; and
selecting at least one of the given datasets from the given datasets for updating the AI-module on the basis of a comparison of the metrics of the given datasets.
